(19) United States
(12) Patent Application Publication
(10) Pub. No.: US 2021/0223499 A1
(43) Pub. Date: Jul. 22, 2021

(54) LIGHT-SHIELDING SHEET CAPABLE OF REDUCING FLARE, LENS MODULE, AND ELECTRONIC DEVICE

(71) Applicant: HON HAI PRECISION INDUSTRY CO., LTD., New Taipei (TW)

(72) Inventors: YA-LAN FENG, New Taipei (TW); CHUN-CHENG KO, New Taipei (TW)

(21) Appl. No.: 16/939,293

(22) Filed: Jul. 27, 2020

(30) Foreign Application Priority Data
Jan. 17, 2020 (CN) 202010055564.0

(51) Int. Cl. G02B 7/02; G02B 5/00; G02B 5/22; H04N 5/225

(52) U.S. Cl. CPC G02B 7/021; H04N 5/2254; G02B 5/223; G02B 5/003

(57) ABSTRACT

A light-shielding sheet is circular in shape and capable of reducing flare, the light-shielding sheet includes a first surface, a second surface opposite to the first surface, and an inclined surface connected to the first surface and the second surface. The first surface, the second surface, and the inclined surface are antireflective surfaces. An inner diameter of the light-shielding sheet adjacent to the first surface is greater than an inner diameter of the light-shielding sheet adjacent to the second surface. The disclosure also relates to a lens module using the light-shielding sheet, and an electronic device using the lens module.

### FIELD

The subject matter of the application generally relates to a light-shielding sheet capable of reducing flare, a lens module using the light-shielding sheet, and an electronic device using the lens module.

### BACKGROUND

The errors or flaws of a lens module will affect the optical properties of the lens module. A light-shielding sheet is often used to block a portion of stray light to avoid the occurrence of flare. A PET (polyethylene terephthalate) layer is defined on the light-shielding sheet. The PET layer has a higher reflectivity, which is easy to cause stray light and affect imaging quality of the lens module. Furthermore, the lens cone and the tip of a light through hole are both easy to cause stray light.

Therefore, there is room for improvement in the art.

### BRIEF DESCRIPTION OF THE DRAWINGS

Implementations of the present disclosure will now be described, by way of embodiments, with reference to the attached figures.

FIG. 1 is a perspective view of an embodiment of a lens module according to the present disclosure.

FIG. 2 is an exploded view of the lens module of FIG. 1.

FIG. 3 is a cross-sectional view along a line of FIG. 1.

FIG. 4 is a partial enlarged view of a light-shielding sheet of FIG. 2.

FIG. 5 is a partial cross-sectional view of the light-shielding sheet of FIG. 4.

FIG. 6 is a perspective view of an electronic device including the lens module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain portions may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

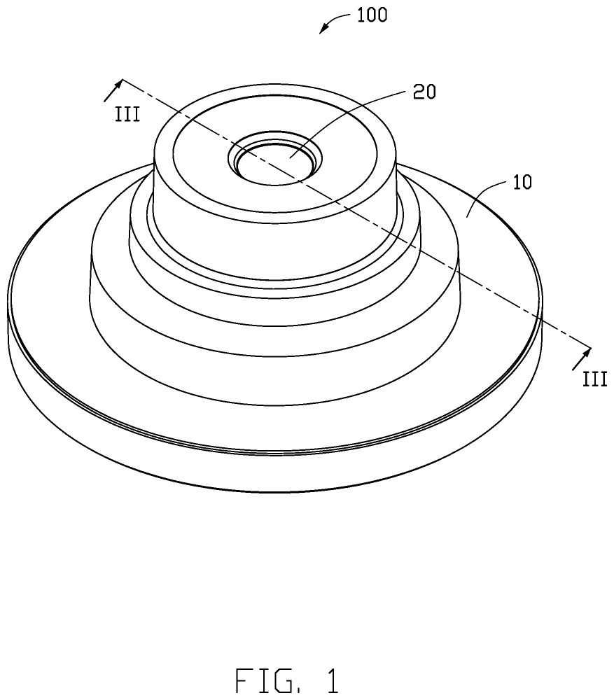

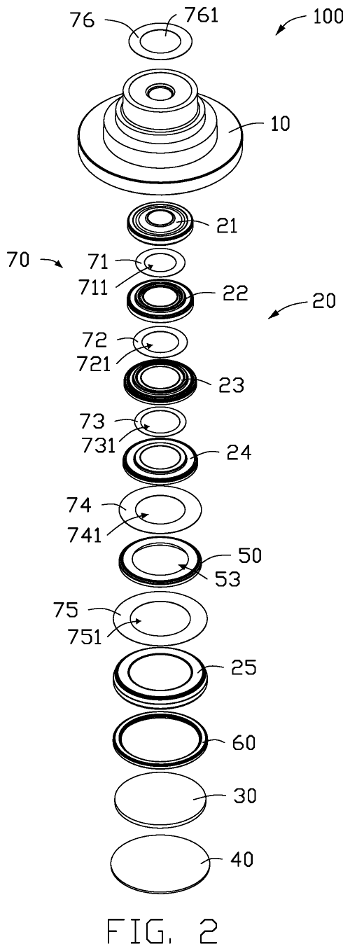

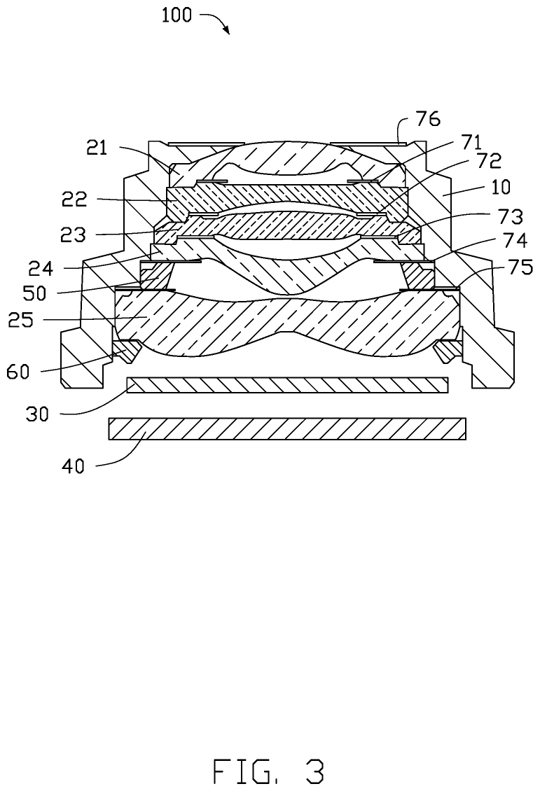

FIGS. 1-3 show an embodiment of a lens module 100. The lens module 100 includes a lens cone 10, a lens group 20, a filter 30, a sensor 40, a gasket 50, a stopper 60, and a light-shielding sheet group 70. The lens group 20, the gasket 50, the stopper 60, and the light-shielding sheet group 70 are received in the lens cone 10. The filter 30 and the sensor 40 are located below the lens cone 10. The filter 30 faces the lens group 20. The sensor 40 is located below the filter 30 and faces the filter 30.

The lens group 20 is fixed in the lens cone 10. The lens group 20 includes a plurality of lenses arranged successively from an object side of the lens module 100 to an image side of the lens module 100. In at least one embodiment, the lens group 20 includes a first lens 21, a second lens 22, a third lens 23, a fourth lens 24, and a fifth lens 25. The first lens 21, the second lens 22, the third lens 23, the fourth lens 24, and the fifth lens 25 are sequentially mounted in the lens cone 10 from the object side of the lens module 100 to the image side of the lens module 100.

The filter 30 and the sensor 40 are located on the image side of the lens module 100. In at least one embodiment, the filter 30 faces and abuts the fifth lens 25.

The gasket 50 is arranged between two adjacent light-shielding sheets arranged on the image side of the lens module 100 to increase the distance between two adjacent lenses to avoid the two adjacent lenses touching with each other. Two light-shielding sheets are arranged between the gasket 50 and two lenses, respectively. In at least one embodiment, the gasket 50 is arranged between the fourth lens 24 and the fifth lens 25. The stopper 60 is arranged below the lens group 20 to prevent the lens group 20 from sliding out of the lens cone 10.

The light-shielding sheet group 70 includes a plurality of light-shielding sheets. The plurality of light-shielding sheets is arranged between two adjacent lenses or between a lens and the gasket 50.

In at least one embodiment, the light-shielding sheet group 70 includes a first light-shielding sheet 71, a second light-shielding sheet 72, a third light-shielding sheet 73, a fourth light-shielding sheet 74, a fifth light-shielding sheet 75, and a sixth light-shielding sheet 76. The sixth light-shielding sheet 76, the first light-shielding sheet 71, the second light-shielding sheet 72, the third light-shielding sheet 73, the fourth light-shielding sheet 74, and the fifth light-shielding sheet 75 are sequentially mounted in the lens cone 10 from the object side of the lens module 100 to the image side of the lens module 100.

The first light-shielding sheet 71 is mounted between the first lens 21 and the second lens 22. The second light-shielding sheet 72 is mounted between the second lens 22 and the third lens 23. The third light-shielding sheet 73 is mounted between the third lens 23 and the fourth lens 24. The fourth light-shielding sheet 74 is mounted between the fourth lens 24 and the gasket 50. The fifth light-shielding sheet 75 is mounted between the gasket 50 and the fifth lens 25. The sixth light-shielding sheet 76 is formed on the lens cone 10 and abuts the first lens 21.

A first through hole 711 is defined in a middle of the first light-shielding sheet 71. A second through hole 721 is defined in a middle of the second light-shielding sheet 72. A third through hole 731 is defined in a middle of the third light-shielding sheet 73. A fourth through hole 741 is defined in a middle of the fourth light-shielding sheet 74. A fifth through hole 751 is defined in a middle of the fifth light-shielding sheet 75. A sixth through hole 761 is defined in a middle of the sixth light-shielding sheet 76.

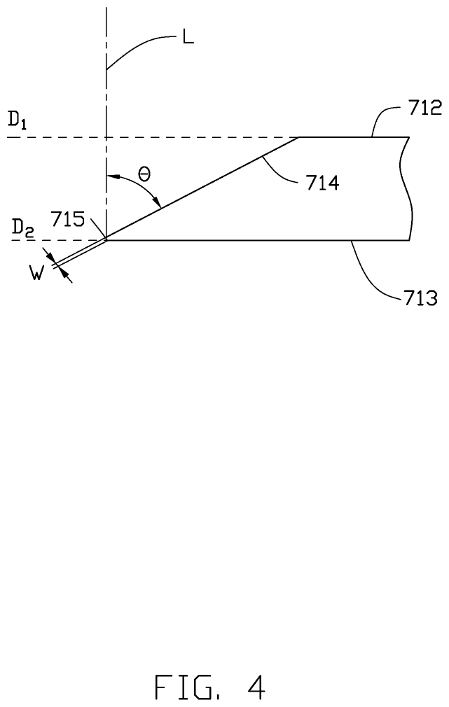

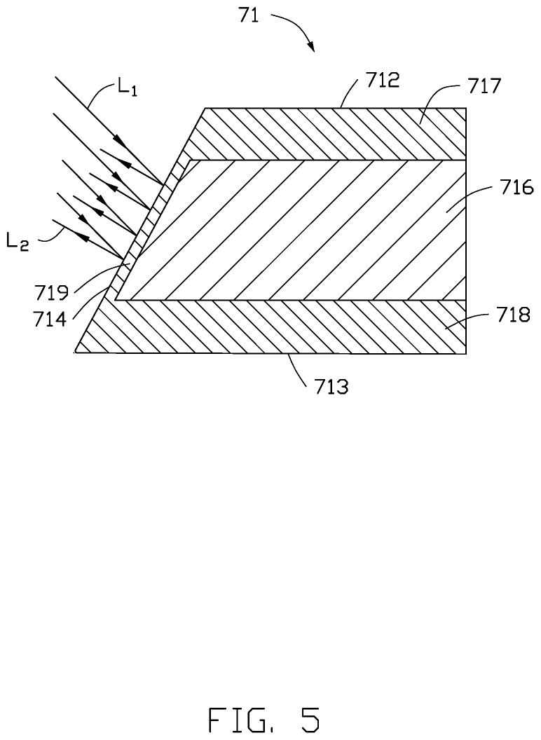

Referring to FIGS. 4 and 5, taking the first light-shielding sheet 71 as an example, the structure of the light-shielding sheets is described as follows.

The first light-shielding sheet 71 is circular in shape. The first light-shielding sheet 71 includes a first surface 712, a second surface 713 opposite to the first surface 712, and an inclined surface 714 connected to the first surface 712 and the second surface 713. The inclined surface 714 faces the lens group 20. The first surface 712, the second surface 713, and the inclined surface 714 are antireflective surfaces.

An inner diameter D1 of the first light-shielding sheet 71 adjacent to the first surface 712 is greater than an inner diameter D2 of the first light-shielding sheet 71 adjacent to the second surface 713.

The first light-shielding sheet 71 has an optical axis L. An included angle 9 between the inclined surface 714 and the optical axis L is greater than or equal to 45°.

The first light-shielding sheet 71 includes a tip 715. The tip 715 is located between the second surface 713 and the inclined surface 714. The width W of the tip 715 is less than or equal to 0.03 mm.

The first light-shielding sheet 71 includes a metal layer 716, a first antireflective film layer 717, a second antireflective film layer 718, and a third antireflective film layer 719 connected to the first antireflective film layer 717 and the second antireflective film layer 718. The first antireflective film layer 717, the second antireflective film layer 718, and the third antireflective film layer 719 are coated on the metal layer 716. The first surface 712 is a surface of the first antireflective film layer 717 away from the metal layer 716. The second surface 713 is a surface of the second antireflective film layer 718 away from the metal layer 716. The inclined surface 714 is a surface of the third antireflective film layer 719 away from the metal layer 716. In at least one embodiment, the first antireflective film layer 717, the second antireflective film layer 718, and the third antireflective film layer 719 are black coating layers.

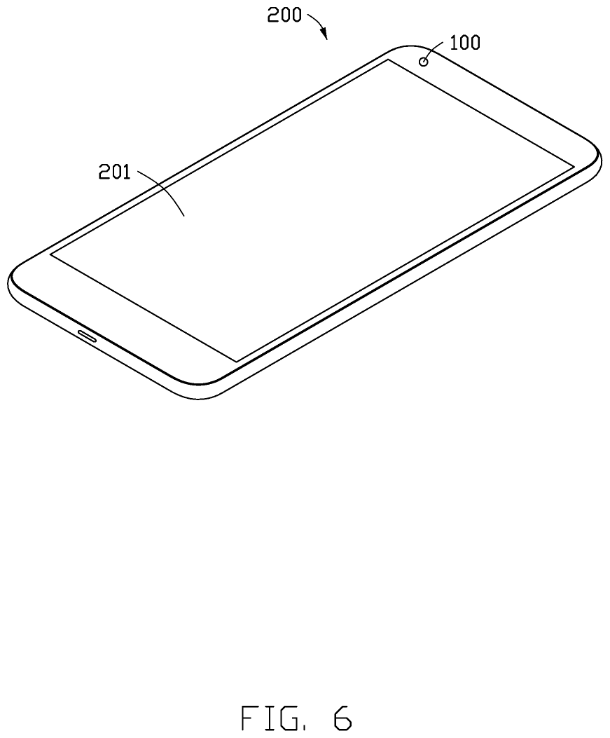

FIG. 6 shows an embodiment of an electronic device 200. The electronic device 200 includes a body 201 and at least one lens module 100 mounted in the body 201. The electronic device 200 may be a smart phone, a tablet computer, or the like. In at least one embodiment, the electronic device 200 is a smart phone.

With the embodiments described above, firstly, the first light-shielding sheet 71 has the inclined surface 714, which can reflect the stray light incident on the inclined surface 714, so that the stray light in the lens module 100 can be reduced, thereby reducing glare; secondly, the included angle 9 between the inclined surface 714 and the optical axis L is greater than or equal to 45° and the width W of the tip 715 is less than or equal to 0.03 mm, which can further reduce glare; thirdly, use a metal layer 716 instead of the polyethylene terephthalate film layer in related art, which can further reduce glare.

The embodiments shown and described above are only examples. Many details are often found in the art such as the other features of a light-shielding sheet capable of reducing flare, a lens module using the lens module, and an electronic device using the lens module. Therefore, many such details are neither shown nor described. Even though numerous characteristics and advantages of the present disclosure have been positioned forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. A light-shielding sheet being circular in shape, the light-shielding sheet comprising:
a first surface;
a second surface opposite to the first surface;
an inclined surface connected to the first surface and the second surface; wherein the first surface, the second surface, and the inclined surface are antireflective surfaces; and an inner diameter of the light-shielding sheet adjacent to the first surface is greater than an inner diameter of the light-shielding sheet adjacent to the second surface.

2. The light-shielding sheet of claim 1, wherein the light-shielding sheet has an optical axis; an included angle between the inclined surface and the optical axis is greater than or equal to 45°.

3. The light-shielding sheet of claim 1, further comprising a metal layer, a first antireflective film layer, a second antireflective film layer, and a third antireflective film layer connected to the first antireflective film layer and the second antireflective film layer; the first antireflective film layer, the second antireflective film layer, and the third antireflective film layer are coated on the metal layer; the first surface is a surface of the first antireflective film layer away from the metal layer; the second surface is a surface of the second antireflective film layer away from the metal layer; and the inclined surface is a surface of the third antireflective film layer away from the metal layer.

4. The light-shielding sheet of claim 3, wherein the first antireflective film layer, the second antireflective film layer, and the third antireflective film layer are black coating layers.

5. The light-shielding sheet of claim 1, further comprising a tip, the tip is located between the second surface and the inclined surface, a width of the tip is less than or equal to 0.03 mm.

6. A lens module comprising:
a lens cone;
a lens group received in the lens cone; wherein the lens group comprises a plurality of lenses arranged successively from an object side of the lens module to an image side of the lens module; and
a light-shielding sheet group arranged between two adjacent lenses; wherein the light-shielding sheet group comprises a plurality of light-shielding sheets, each of the plurality of light-shielding sheets comprises:
a first surface;
a second surface opposite to the first surface;
an inclined surface connected to the first surface and the second surface; wherein the first surface, the second surface, and the inclined surface are antireflective surfaces; an inner diameter of the light-shielding sheet adjacent to the first surface is greater than an inner diameter of the light-shielding sheet adjacent to the second surface; and the inclined surface faces the lens.

7. The lens module of claim 6, wherein the light-shielding sheet has an optical axis; an included angle between the inclined surface and the optical axis is greater than or equal to 45°.

8. The lens module of claim 6, further comprising a metal layer, a first antireflective film layer, a second antireflective film layer, and a third antireflective film layer connected to the first antireflective film layer and the second antireflective film layer; the first antireflective film layer, the second antireflective film layer, and the third antireflective film layer are coated on the metal layer; the first surface is a surface of the first antireflective film layer away from the metal layer; the second surface is a surface of the second antireflective film layer away from the metal layer; and the inclined surface is a surface of the third antireflective film layer away from the metal layer.

9. The lens module of claim 8, wherein the first antireflective film layer, the second antireflective film layer, and the third antireflective film layer are black coating layers.

10. The lens module of claim 6, further comprising includes a tip, the tip is located between the second surface and the inclined surface, a width of the tip is less than or equal to 0.03 mm.

11. The lens module of claim 6, further comprising a gasket received in the lens cone; wherein the lens group further comprises a first lens, a second lens, a third lens, a fourth lens, and a fifth lens sequentially mounted in the lens cone from the object side of the lens module to the image side of the lens module; and the light-shielding sheet group comprises a sixth light-shielding sheet formed on the lens cone and abutting the first lens, a first light-shielding sheet mounted between the first lens and the second lens, a second light-shielding sheet mounted between the second lens and the third lens, a third light-shielding sheet mounted between the third lens and the fourth lens, a fourth light-shielding sheet mounted between the fourth lens and the gasket, and a fifth light-shielding sheet mounted between the gasket and the fifth lens.

12. The lens module of claim 6, further comprising a stopper received in the lens cone and arranged below the lens group.

13. The lens module of claim 6, further comprising a filter and a sensor; wherein the filter and the sensor are located below the lens cone; the filter faces the lens group; and the sensor is located below the filter and faces the filter.

14. An electronic device comprising:
a body;
a lens module mounted in the body; wherein the lens module comprises:
a lens cone;
a lens group received in the lens cone; wherein the lens group comprises a plurality of lenses arranged successively from an object side of the lens module to an image side of the lens module; and
a light-shielding sheet group arranged between two adjacent lenses; wherein the light-shielding sheet group comprises a plurality of light-shielding sheets, each of the plurality of light-shielding sheets comprises:
a first surface;
a second surface opposite to the first surface;
an inclined surface connected to the first surface and the second surface; wherein the first surface, the second surface, and the inclined surface are antireflective surfaces; an inner diameter of the light-shielding sheet adjacent to the first surface is greater than an inner diameter of the light-shielding sheet adjacent to the second surface; and the inclined surface faces the lens.

15. The electronic device of claim 14, wherein the light-shielding sheet has an optical axis; an included angle between the inclined surface and the optical axis is greater than or equal to 45°.

16. The electronic device of claim 14, wherein the light-shielding sheet comprises a metal layer, a first antireflective film layer, a second antireflective film layer, and a third antireflective film layer connected to the first antireflective film layer and the second antireflective film layer; the first antireflective film layer, the second antireflective film layer, and the third antireflective film layer are coated on the metal layer; the first surface is a surface of the first antireflective film layer away from the metal layer; the second surface is a surface of the second antireflective film layer away from the metal layer; and the inclined surface is a surface of the third antireflective film layer away from the metal layer.

17. The electronic device of claim 14, wherein the first light-shielding sheet includes a tip, the tip is located between the second surface and the inclined surface, a width of the tip is less than or equal to 0.03 mm.

18. The electronic device of claim 14, wherein the lens module further comprises a gasket received in the lens cone; the lens group further comprises a first lens, a second lens, a third lens, a fourth lens, and a fifth lens sequentially mounted in the lens cone from the object side of the lens module to the image side of the lens module; and the light-shielding sheet group comprises a sixth light-shielding sheet formed on the lens cone and abutting the first lens, a first light-shielding sheet mounted between the first lens and the second lens, a second light-shielding sheet mounted between the second lens and the third lens, a third light-shielding sheet mounted between the third lens and the fourth lens, a fourth light-shielding sheet mounted between the fourth lens and the gasket, and a fifth light-shielding sheet mounted between the gasket and the fifth lens.

19. The electronic device of claim 14, wherein the lens module further comprises a stopper received in the lens cone and arranged below the lens group.

20. The electronic device of claim 14, wherein the lens module further comprises a filter and a sensor; the filter and the sensor are located below the lens cone; the filter faces the lens group; and the sensor is located below the filter and faces the filter.
